(19) United States
(12) Patent Application Publication
(10) Pub. No.: US 2009/0093063 A1
(43) Pub. Date: Apr. 9, 2009

(54) Color Changing and Coverage Indicating Hand Sanitizer

(76) Inventors: Eric V. Anslyn, Austin, TX (US); Robert Eugene Hanes, Austin, TX (US)

Correspondence Address: CHALKER FLORES, LLP, 2711 LBJ FRWY, Suite 1036, DALLAS, TX, 75234, US

(21) Appl. No.: 12/205,860

(22) Filed: Sep. 6, 2008

Related U.S. Application Data
(60) Provisional application No. 60/970,852, filed on Sep. 7, 2007.
(60) Provisional application No. 60/970,846, filed on Sep. 7, 2007.

(51) Int. Cl. G01N 21/94

(52) U.S. Cl. 436/164

(57) ABSTRACT

The present invention includes compositions and methods for detection of the effectiveness of a substance for cleaning that include an electrophilic dye, wherein the electrophilic dye is colorless before exposure to a nucleophilic agent, and an nucleophilic agent, wherein the electrophilic dye, the nucleophilic agent or both are encapsulated and wherein exposure to one or more cognate target or condition triggers the release of the electrophilic dye, the nucleophilic agent or both from encapsulation. It also includes compositions and methods for detection of the effectiveness of a substance for cleaning by a recognitive dye, wherein the dye is colorless before exposure to its cognate target, changes color upon exposure to its cognate target and reverts to being colorless after a predetermined period of time by exposure to one or more environmental agents.

### CROSS-REFERENCE TO RELATED APPLICATIONS

This application claims priority to U.S. Provisional Application Ser. No. 60/970,852, filed Sep. 7, 2007 and U.S. Provisional Application Ser. No. 60/970,846, filed Sep. 7, 2007, the entire contents of which are incorporated herein by reference.

### TECHNICAL FIELD OF THE INVENTION

The present invention relates in general to the field of hand sanitizers, and more particularly, to compositions and methods for indicating the extent of sanitizer exposure and effectiveness.

### BACKGROUND OF THE INVENTION

Without limiting the scope of the invention, its background is described in connection with hand sanitizers.

There has been a significant interest in the detection of chemical agents and analytes, with a large focus on certain chemical agents, whether considered contaminants, pathogens, or chemicals of interest. Chemical detection of agents has been a long-term ambition for many researchers, even more so in this day and age due to the continuing global threat of terrorist activity. One approach that has been studied uses chromogenic detector reagents, which directly bind to a target nerve agent causing a modulation in the emitted UV-Vis wavelength. However, there are limitations in the calorimetric systems developed thus far, including low sensitivity and slow response times. Presently, chemical detection of agents that are more common and applicable for everyday use by consumers.

Optical-based chemical sensors have been under development for many decades. They offer advantages over other sensing methodologies, such as multiplex sensing probe sensing, and distributed sensing. Some of the early works incorporated chromogenic advances in the development of hand-held portable devices for sensing small quantities of chemical agents but they lack sensitivity. It is well-known that Fluorescence spectroscopy is more sensitive than UV-Vis spectroscopy. Therefore, it is believed that lower levels of chemical agents will be detected.

Successful application of personal cleansing products requires a minimum or maximum use time indication. Consumers are unlikely to use clocks or timers, hence indicators within the product are desired to denote the optimum duration of use. Color changing indicators that can teach good habits and lead the consumer to fully experience the designed benefits of this foam (or liquid) product are preferred.

Without limiting the scope of the invention, its background is described in connection with hand sanitizers.

### SUMMARY OF THE INVENTION

In one embodiment, the present invention includes compositions and methods for detection of the effectiveness of a substance for cleaning comprising: an electrophilic dye, wherein the electrophilic dye is colorless before exposure to a nucleophilic agent, and an nucleophilic agent, wherein the electrophilic dye, the nucleophilic agent or both are encapsulated and wherein exposure to one or more cognate target or condition triggers the release of the electrophilic dye, the nucleophilic agent or both from encapsulation. In one aspect, the composition is adapted for household products selected from laundry care; paper products; specialty cleaners (chlorinated cleaners, scouring pads, effervescent toilet bowl cleaner powders); air fresheners and combinations thereof. In another aspect, the composition is adapted for personal care selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof. The composition is adapted for the detection of desired levels of cleanliness, detection of microorganisms in cleaning products, detection of contamination of surfaces, detection of microorganisms in cleaning products and combinations thereof or even for use in sanitizers that do not require a rinse. In one aspect, the composition is biodegradable, biocompatible or both. Examples of conditions that may trigger the release of the components of the composition include, but are not limited to, pressure, friction, temperature change, gas, electromagnetic radiation, ultrasound, humidity and combinations thereof. In one example, the nucleophile is an oxamate anion that quenches an excited state of an electrophilic dye.

Another embodiment of the present invention is a dye system composition comprising: a container comprising: an electrophilic dye, wherein the electrophilic dye is colorless before exposure to a nucleophilic agent, and an nucleophilic agent, wherein the electrophilic dye, the nucleophilic agent or both are encapsulated, wherein exposure to one or more cognate target or condition triggers the release of the electrophilic dye, the nucleophilic agent or both from encapsulation. In one aspect, the composition is adapted for household products selected from laundry care; paper products; specialty cleaners (chlorinated cleaners, scouring pads, effervescent toilet bowl cleaner powders); air fresheners and combinations thereof. In another aspect, the composition is adapted for personal care selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof. The composition is adapted for the detection of desired levels of cleanliness, detection of microorganisms in cleaning products, detection of contamination of surfaces, detection of microorganisms in cleaning products and combinations thereof or even for use in sanitizers that do not require a rinse. In one aspect, the composition is biodegradable, biocompatible or both. Examples of conditions that may trigger the release of the components of the composition include, but are not limited to, pressure, friction, temperature change, gas, electromagnetic radiation, ultrasound, humidity and combinations thereof. In one example, the nucleophile is an oxamate anion that quenches an excited state of an electrophilic dye.

In yet another embodiment, the present invention includes a method for detection of the effectiveness of a composition for cleaning comprising: providing an electrophilic dye, wherein the electrophilic dye is colorless before exposure to a nucleophilic agent and a nucleophilic agent, wherein the electrophilic dye, the nucleophilic agent or both are encapsulated, wherein exposure to one or more cognate target or condition triggers the release of the electrophilic dye, the nucleophilic agent or both from encapsulation; and exposing the electrophilic dye and the nucleophilic agent to one or more conditions that trigger their release, wherein the dye reverts to a colorless state after a predetermined period of time by exposure to the nucleophilic agent. In one aspect, the composition is adapted for household products selected from laundry care; paper products; specialty cleaners (chlorinated cleaners, scouring pads, effervescent toilet bowl cleaner powders); air fresheners and combinations thereof. In another aspect, the composition is adapted for personal care selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof. The composition is adapted for the detection of desired levels of cleanliness, detection of microorganisms in cleaning products, detection of contamination of surfaces, detection of microorganisms in cleaning products and combinations thereof or even for use in sanitizers that do not require a rinse. In one aspect, the composition is biodegradable, biocompatible or both. Examples of conditions that may trigger the release of the components of the composition include, but are not limited to, pressure, friction, temperature change, gas, electromagnetic radiation, ultrasound, humidity and combinations thereof. In one example, the nucleophile is an oxamate anion that quenches an excited state of an electrophilic dye.

In one embodiment, the present invention is a composition and method for detection of the effectiveness of a substance for cleaning comprising a recognitive dye, wherein the dye is colorless before exposure to its cognate target, changes color upon exposure to its cognate target and reverts to being colorless. In one aspect, the composition is adapted for use in sanitizers that do not require a rinse. In another aspect, the composition is colorless until exposed to ions that cause the dye to change color. The composition may be biodegradable, biocompatible or both. The composition may be biodegradable, biocompatible or both. In another aspect, composition further comprises an encapsulated chelation agent, wherein pressure on the encapsulation triggers the release of the chelation agent. In another aspect, the composition further comprises an encapsulated deactivator, wherein pressure, friction, heat or a combination thereof on the encapsulation triggers the release of the deactivator. In one aspect, the deactivator comprises a nucleophilic scavenger. The composition can be adapted for use in sanitizers that do not require a rinse. In one aspect, the dye does not stain skin, hair or clothing. In another aspect, the dye is safe and mild for skin and eye contact. In one aspect, the dye is a reversible amidine dye that reverts to colorless by exposure to CO₂.

In another embodiment, the present invention includes a dye system composition comprising: a chemical dye having an reactive site and a functional group, wherein the dye has a high affinity for a cognate bingeing agent and is colorless in the absence of the cognate bingeing agent; and one or more encapsulated chelating agents, wherein mild friction breaks the encapsulation. In one aspect, the composition is adapted for use in sanitizers that do not require a rinse. In another aspect, the composition is colorless until exposed to ions that cause the dye to change color. The composition may be biodegradable, biocompatible or both. In another aspect, composition further comprises an encapsulated chelation agent, wherein pressure on the encapsulation triggers the release of the chelation agent. The composition can be adapted for use in sanitizers that do not require a rinse. In another aspect, the composition further comprises an encapsulated deactivator, wherein pressure, friction, heat or a combination thereof on the encapsulation triggers the release of the deactivator. In one aspect, the deactivator comprises a nucleophilic scavenger. In one aspect, the dye does not stain skin, hair or clothing. In another aspect, the dye is safe and mild for skin and eye contact. In one aspect, the system is adapted for the detection of coverage of sanitizer on the desired cleaning area. In yet another aspect, the system is adapted for the disappearance of the detection system upon reaching the desired coverage. In one aspect, the dye is a reversible amidine dye that reverts to colorless by exposure to CO₂.

Another embodiment of the present invention is a method for detection of the effectiveness of a composition for cleaning comprising: providing a recognitive dye, wherein the dye is colorless before exposure to its cognate target, changes color upon exposure to its cognate target and reverts to being colorless; exposing the recognitive dye to a surface suspected of having the dye's cognate target, wherein exposure to the cognate target changes the dye from colorless to colored, and wherein the dye reverts to a colorless state after a predetermined period of time by exposure to one or more environmental agents. In one aspect, the composition is adapted for use in sanitizers that do not require a rinse. In another aspect, the composition is colorless until exposed to ions that cause the dye to change color. The composition may be biodegradable, biocompatible or both. In another aspect, composition further comprises an encapsulated chelation agent, wherein pressure on the encapsulation triggers the release of the chelation agent. In another aspect, the composition further comprises an encapsulated deactivator, wherein pressure, friction, heat or a combination thereof on the encapsulation triggers the release of the deactivator. In one aspect, the deactivator comprises a nucleophilic scavenger. The composition can be adapted for use in sanitizers that do not require a rinse. In one aspect, the dye does not stain skin, hair or clothing. In another aspect, the dye is safe and mild for skin and eye contact. In one aspect, the system is adapted for the detection of coverage of sanitizer on the desired cleaning area. In yet another aspect, the system is adapted for the disappearance of the detection system upon reaching the desired coverage. In one aspect, the dye is a reversible amidine dye that reverts to colorless by exposure to CO₂.

### BRIEF DESCRIPTION OF THE DRAWINGS

For a more complete understanding of the features and advantages of the present invention, reference is now made to the detailed description of the invention along with the accompanying figures and in which:

FIG. 1 shows the color scavenger—a nucleophile triggered color change.

FIG. 2 shows a color change mediated via self-assembled supramolecules.

FIG. 3 shows a foaming soap color change triggered by passing through foaming screen.

FIG. 4 shows an example of bicinhoninic acid chemistry interacting with a copper ion.

FIG. 5 shows an example of dye modulation achieved via pH control and quenching compound.

FIG. 6 shows color changes using micro-encapsulation.

FIG. 7 shows color changes mediated through the sequestration of carbon dioxide.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The dyes suitably employed in the practice of the invention are water-soluble amphiphilic dyes (dyes having hydrophilic and a hydrophobic components). The amphiphilic dye may a reactive dye covalently bonded to a hydrophobe. Water-soluble amphiphilic dyes, suitable in the present invention, include any dye having a chromophore and at least one hydrophobic arm attached thereto, the hydrophobic arm having from about 2 to about 30 carbon atoms, more preferably, from about 3 to about 15, and most preferably, from about 5 to about 12 carbon atoms. The amphiphilic dye may even be a non-reactive dye (such as acid or basic dyes) having a hydrophobic arm attached thereto.

In another example, the dye may be a “reactive dye” which is a colored compound having reactive groups capable of covalently bonding with a substrate. Reactive dyes typically include a chromophore soluble in water, such as anthraquinone, a monoazo dye, or diazo dye, a phthalocyanine, an aza[18]annulene, a formazan copper complex, a triphenodioxazine, and the like, to which a reactive group is attached. Generally, the reactive group of a reactive dye has a leaving group X that may undergo nucleophilic displacement by a group in a hydrophobe, such as the hydroxyl group (—OH) of a long-chain alcohol. Thus, the nucleophilic displacement of a leaving group X of a reactive dye molecule with a group of a hydrophobe results in the attachment of the reactive dye to the hydrophobe by an ester, ether, amide, or a similar covalent linkage. It is contemplated that any reactive dye having a reactive group with a leaving group X may benefit from the practice of the invention. Non-limiting examples of reactive dyes include, e.g., sulphate esters of the hydroxyethylsulphones, (e.g. Remazol dyes available from Hoechst); dyes based on triazines, (mono, di, and tri chloro/fluoro triazines such as those available from ICI under the trade name Procion dyes); pyrimidine derivative dyes such as trichloropyrimidines and chlorofloropyrimidine (available from Sandoz); phosphonic acid reactive dyes such as Procion T dyes, e.g., RR177, RR179, and RV 35 all available from Zeneca; and quaternized nicolinic acid derivative dyes, such as Procion Blue H-EG available from Zeneca, and Kayacelon Reactive orange, available from Nippon Kayaku.

According to certain example embodiments, the present disclosure provides chemical receptors and chromophores useful for, among other things, detecting the presence of certain chemicals, analytes or conditions. These fluorophores may be capable of detecting certain chemicals, analytes, or conditions, such as, water contaminants, infections, time exposure, pregnancy, disease, toxins, and additional conditions of interest, at low concentrations. Accordingly, the present disclosure may be used in application such as detection of concentration of chemicals or toxins at a certain level or threshold. The system also may be used, among other things, in systems and methods for detecting chemical agents. In such systems, the chemical receptor can be coupled to a chromophore, for example, to form optical sensors. These compositions may give a modulation in the UV-Vis spectrum and/or the fluorescence signal is switched on, once exposed to the chemical agent. One advantage in the development of optical polymer sensor systems is the ability of the sensors to be used in a qualitative ‘naked eye’ analysis; thus reducing the need to use expensive spectroscopic equipment for detection.

Examples of active agents for use with the present invention include food applications, detergents, bleaches, fabric softeners, fragrances, cosmetic products, air fresheners, room deodorant devices, perfumed substrates, perfumed plastics and pet collars. Other actives include food and cosmetic applications that use hydrocolloids as imprinting carriers for polymers of high molecular weight, wherein the hydrocolloids are extracted from plants, seaweeds or animal collagen, produced by microbial synthesis, and comprise polysaccharides, proteins and combinations thereof. Other examples include household products selected from laundry care; paper products; specialty cleaners (chlorinated cleaners, scouring pads, effervescent toilet bowl cleaner powders); air fresheners and combinations thereof. Further examples include personal care products selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof. Also, cosmetics and treatment products selected from lipstick; eye-liner; foundation; base; blush; mascara; eye shadow; lip liner; facial powder; consealer; facial cream; make-up remover; mascara remover; make-up; skin treatments and may even include one or more fragrances or carriers therefore that include cologne; perfume; sampling; antiperspirant; deodorant; anti-dandruff shampoos; athlete foot products and combinations thereof. Other actives include a surfactant, a bleaching agent, a corrosion inhibitor, a sudsing modifier, a fluorescent whitening agent, one or more enzymes, an anti redeposition agent, a color, a fragrance, one or more additives and combinations thereof.

In operation, the chromophores may be “turned-on” when a chemical agent, such as a contaminant, is added. The oxamate anion has high energy lone pair orbitals that may perform photoinduced electron transfer (PET) quenching of the excited state of a variety of common chromophores. Upon phosphorylation by a contaminant, the energy of these orbitals is dramatically lowered, reducing the PET quenching effect and turning on the fluorescence. Once the oxime is deprotonated to form an oxamate a fast phosphorylation occurs producing fluorescence modulation (the signal is “turned on” via a PET mechanism). The kinetics of reaction may be increased by incorporating into the chromophore a second functional group.

It must be noted that although the description above uses certain household products as a chemical agent, similar problems have been observed with the detection of other active or bioactive agents, such as (but not limited to): pesticides, herbicides, other agricultural products, molluscicides, other marine biology products, insecticides, essential oils, perfumes, agents used in kitchen products, whitening agents used in laundry detergents. Essential oils are complex mixtures of numerous compounds, they are aromatic oily liquid and can be extracted from various parts of the plants. Some of the main chemical groups found in essential oils include alcohols, aldehydes, esters, ethers, ketones, phenols and terpenes. Their use is mostly related to food as flavoring, to perfumes as fragrances and to pharmaceuticals for their functional properties. To date they are widely used as air freshener, several patents are reported dealing with their applications as deodorant, some are related to their use as good smelling insect repellent. In the literature several works reports on their use to improve the shelf-life and safety of food and packaged food. As such, a desire exists to have a line of hand soaps that when packaged are colored and upon dispensing onto a user's hands begin to change color within a 20 second time frame. This particular line of soaps will include a final rinse cycle with water.

Current color changing soap formulations in general rely upon dyes that have a known reactivity to either aerobic/anaerobic conditions or simple pH changes. While these approaches are theoretically feasible, they present several challenges related to packaging constraints and user related interfering conditions. As such, the approaches generated below encompass novel concepts intended to leverage unique properties of dye-surfactant systems. Therefore, the present invention is well adapted to attain the ends and advantages mentioned as well as those that are inherent therein. While numerous changes may be made by those skilled in the art, such changes are encompassed within the spirit of this invention as defined by the appended claims.

### EXAMPLE 1

### Encapsulated Nucleophilic Dye Quenching Color Scavenger

This example uses the following materials with the following attributes: The following product technical requirements listed below were taken into consideration in the generation of this proposal:
Function and be stable in pH range of 4.0-7.5.
Provide a color change after ˜20 seconds of hand washing.
Not stain skin, hair or clothing.
Be environmentally benign.
Deliver bright or pastel colors.
Desired rheology would be compatible with liquid base formulation that is passed through a foam creating screen during dispensing.
Be safe and mild for skin and eye contact (fulfill global regulatory requirements for cosmetic ingredients).

A pleasantly colored, electrophilic dye [E⁺] would provide the platform through which a color change would occur via the shear process of rubbing the hands over each other.

The key step to bring about the change would rely upon the interaction of an encapsulated nucleophile [Nuc⁻] activated while rubbing the hands together. The encapsulation process (standard micro-encapsulation techniques) would protect the nucleophile from reacting with the dye prior to dispensing. While undetectable to the consumer, the suspended 20 micron sized particles would encourage proper hygiene by necessitating adequate hand washing to promote color change by the nucleophilic scavenger. Due to the fact that the color change is incremental, and depends upon proper hand washing, the consumer receives immediate visual feedback and learns the correct technique.

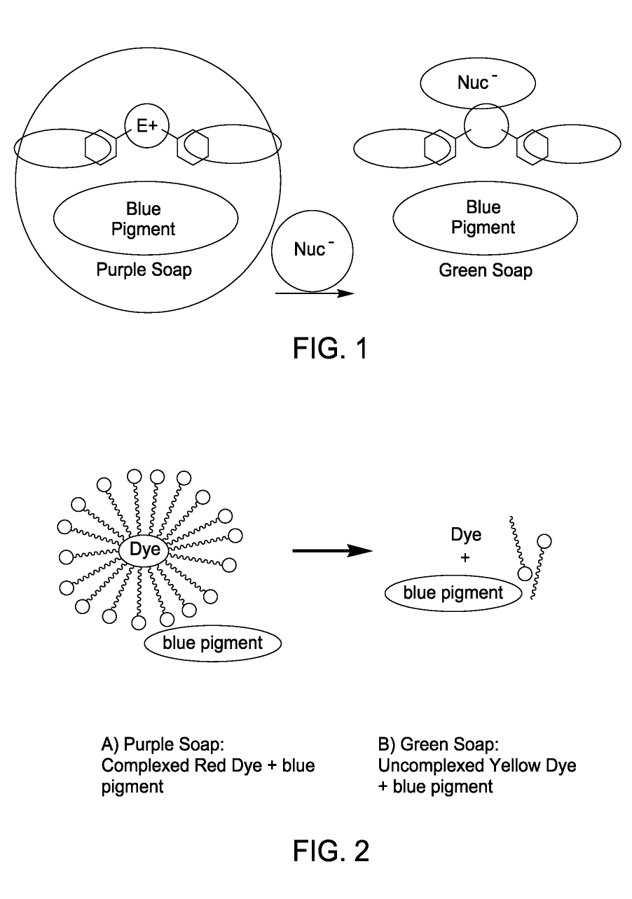

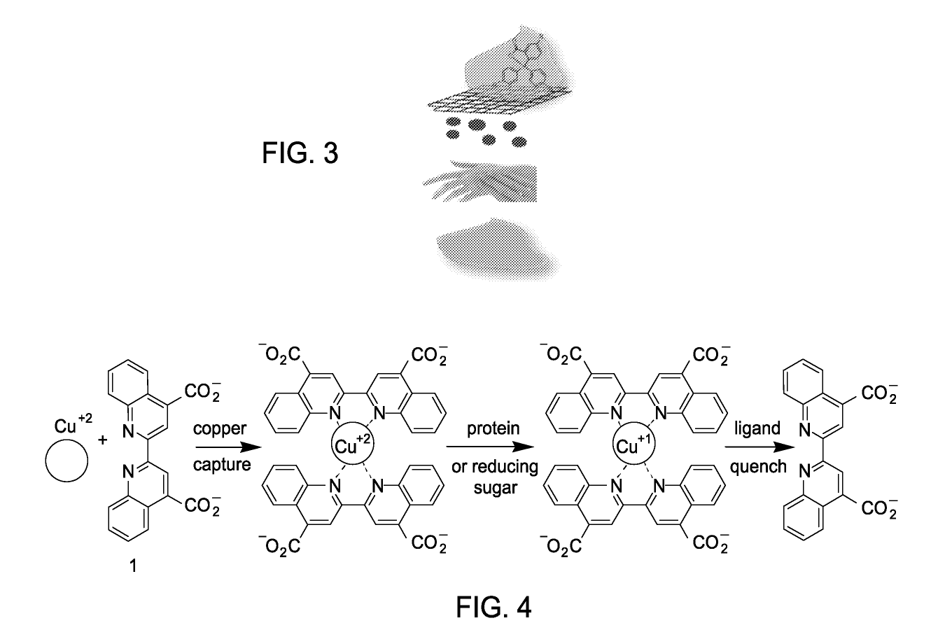

FIG. 1 shows the color scavenger—a nucleophile triggered color change in which: (A) is a purple soap and (B) green soap, briefly, the complexed red and blue dyes give the composition a purple color. Upon activation, the red dye is attacked and destroyed, yielding a blue and yellow dye combination that together give a green color.

FIG. 2 shows the color change mediated via self-assembled supramolecules. Briefly, the red dye is formed into self-assembled supramolecules with a blue dye to give the composition a purple color. Upon activation or disassembly of the red dye is converted into a yellow dye upon exposure to conditions outside the self-assembled supramolecule, yielding a blue and yellow dye combination that together yield a green color.

The color changes occur specifically through the incorporation of a blue pigment and a reactive red dye that in combination turn yellow upon interaction with the nucleophile. To the consumer the color change would transition from purple to green.

### EXAMPLE 2

### Self-Assembling Surfactant Dye

This example uses the following materials with the following attributes:

Amphiphilic dyes designed to self-assemble would be colored purple until disrupted. The supramolecular assembly controls the mechanism through which the color change occurs. Once the assembly is disrupted, a visual color change is detected.

These microcapsules, self assembled by the electronic and hydrophobic properties of the dye and surfactant, provide a novel method to manipulate dye colors while including ingredients compatible with existing formulations. (Note: These microcapsules are not an encapsulation technology).

When complexed within the self-assembled microcapsule, the dye would appear purple and then began a change to green as the consumer starts rubbing their hands together. Once the color was completely green, it would be time to rinse the soap.

If the desirable colors could not be achieved with the soap-dye complex alone, a secondary pigment would be used. As a practical example, a color changing dye, when complexed within the microcapsule formed by the surfactant, would appear red. By adding a blue pigment to the base soap, the combination of red and blue would result in a purple colored product to the end user. Once the product is dispensed, and the consumer begins proper hand washing technique, disruption of the supramolecular assembly occurs due to the shear forces resulting from rubbing the hands together. Once the supramolecular complex dissociates, the complexed dye now appears yellow. In combination with the already present blue pigment, the resulting color change has made the purple appear green, signaling the right time for rinsing the hands.

If sufficient color control could not be maintained by the self-assembled microcapsule, the color change technology would be triggered with carbon dioxide as an intramolecular pH switch. By using amphiphilic amidines, known to reversibly capture carbon dioxide, a pH indicator dye's color would change upon loss of CO2 to the atmosphere. As the amidines are know to be basic, loss of CO2 results in an increase in the pH triggering the change in color for the dye.

### EXAMPLE 3

### Color Change Triggered Through Foaming

This example uses the following materials with the following attributes:

A Surfactant Leuco Dye would change color upon foaming. Leuco dyes are colorless in their insoluble form and color returns upon, e.g., oxidation. These custom leuco dyes (characterized by colorless to color changes and visa versa) are tuned to change color with pressure. The change in pressure resulting from foaming would result in a color change. Should the native color change be the wrong hue, a secondary pigment would be added to ensure the desired hue is achieved.

The Leuco Dye possesses an intramolecular lactone that opens then closes in response to pressure changes. Once forced through the foaming screen, the dye responds by ring opening, resulting in a highly colored zwitterionic salt complex. As the consumer massages the colored soap over the hands, the bubbles in the foam begin rupturing resulting in a color change.

Coverage Indicating Hand Sanitizer.

According to certain example embodiments, the present disclosure provides chemical receptors and chromophores useful for, among other things, detecting the presence of certain chemicals, analytes or conditions. These fluorophores may be capable of detecting certain chemicals, analytes, or conditions, such as, water contaminants, infections, time exposure, pregnancy, disease, toxins, and additional conditions of interest, at low concentrations. Accordingly, the present disclosure may be used in application such as detection of concentration of chemicals or toxins at a certain level or threshold. The system also may be used, among other things, in systems and methods for detecting chemical agents. In such systems, the chemical receptor can be coupled to a chromophore, for example, to form optical sensors. These compositions may give a modulation in the UV-Vis spectrum and/or the fluorescence signal is switched on, once exposed to the chemical agent. One advantage in the development of optical polymer sensor systems is the ability of the sensors to be used in a qualitative ‘naked eye’ analysis; thus reducing the need to use expensive spectroscopic equipment for detection.

Examples of active agents for use with the present invention include food applications, detergents, bleaches, fabric softeners, fragrances, cosmetic products, air fresheners, room deodorant devices, perfumed substrates, perfumed plastics and pet collars. Other actives include food and cosmetic applications that use hydrocolloids as imprinting carriers for polymers of high molecular weight, wherein the hydrocolloids are extracted from plants, seaweeds or animal collagen, produced by microbial synthesis, and comprise polysaccharides, proteins and combinations thereof. Other examples include household products selected from laundry care; paper products; specialty cleaners (chlorinated cleaners, scouring pads, effervescent toilet bowl cleaner powders); air fresheners and combinations thereof. Further examples include personal care products selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof. Also, cosmetics and treatment products selected from lipstick; eye-liner; foundation; base; blush; mascara; eye shadow; lip liner; facial powder; consealer; facial cream; make-up remover; mascara remover; make-up; skin treatments and may even include one or more fragrances or carriers therefore that include cologne; perfume; sampling; antiperspirant; deodorant; anti-dandruff shampoos; athlete foot products and combinations thereof. Other actives include a surfactant, a bleaching agent, a corrosion inhibitor, a sudsing modifier, a fluorescent whitening agent, one or more enzymes, an anti redeposition agent, a color, a fragrance, one or more additives and combinations thereof.

In operation, the chromophores may be “turned-on” when a chemical agent, such as a contaminate, is added. The oxamate anion has high energy lone pair orbitals that may perform photoinduced electron transfer (PET) quenching of the excited state of a variety of common chromophores. Upon phosphorylation by a contaminant, the energy of these orbitals is dramatically lowered, reducing the PET quenching effect and turning on the fluorescence. Once the oxime is deprotonated to form an oxamate a fast phosphorylation occurs producing fluorescence modulation (the signal is “turned on” via a PET mechanism). The kinetics of reaction may be increased by incorporating into the chromophore a second functional group.

It must be noted that although the description above uses certain household products as a chemical agent, similar problems have been observed with the detection of other active or bioactive agents, such as (but not limited to): pesticides, herbicides, other agricultural products, molluscicides, other marine biology products, insecticides, essential oils, perfumes, agents used in kitchen products, whitening agents used in laundry detergents. Essential oils are complex mixtures of numerous compounds, they are aromatic oily liquid and can be extracted from various parts of the plants. Some of the main chemical groups found in essential oils include alcohols, aldehydes, esters, ethers, ketones, phenols and terpenes. Their use is mostly related to food as flavoring, to perfumes as fragrances and to pharmaceuticals for their functional properties. To date they are widely used as air freshener, several patents are reported dealing with their applications as deodorant, some are related to their use as good smelling insect repellent. In the literature several works reports on their use to improve the shelf-life and safety of food and packaged food. As such, a desire exists to have a line of hand soaps that when packaged are colored and upon dispensing onto a user's hands begin to change color within a ˜20 second time frame. This particular line of soaps will include a final rinse cycle with water.

The inclusion of a coverage indicating colorant or dye system into a sanitizing solution in of itself is a fairly straight forward task. However, multiple color changes within a short time frame in addition to the fact that the sanitizer solution will not be washed away with a rinse step is desired. As such a combination of unique solutions should be considered to achieve the desired results. This particular project will draw upon molecular recognition as it pertains to binding chromophores in different conformational states and thereby controlling the optical output. Additionally, this approach relies upon custom synthesized compounds and will require a slightly longer timeframe to achieve initial proof-of-concept. The proposed approaches all represent unique chemistry that if honed and developed appropriately would enable the appropriate sequence of color changes. Additionally, these approaches could be used in combination with other approaches for future product enhancements and would provide a solid IP base to build upon. The following technical requirements listed below were taken into consideration in this invention:

1. pH of current formulation is about 3
2. Desire to have a colorless product in the bottle
3. Color developing quickly when sprayed on the hands
4. Color disappearing in about 30-60 seconds once the product has been rubbed on the hands.
5. Not stain skin, hair or clothing
6. Be environmentally benign
7. Deliver bright or pastel colors
8. Be safe and mild for skin and eye contact (fulfill global regulatory requirements for cosmetic ingredients)

Therefore, the present invention is well adapted to attain the ends and advantages mentioned as well as those that are inherent therein. While numerous changes may be made by those skilled in the art, such changes are encompassed within the spirit of this invention as defined by the appended claims.

### EXAMPLE 4

### Chelation Controlled Color Changes

This example would ideally utilize the following materials and have the subsequent attributes: (1) Use of chelation controlled chemistry and molecular recognition scaffolds. (2) Common metal ions on the skin as part of healthy metabolism include: Calcium, Copper, Sodium and Potassium, which are used as triggers to activate ligands for sensitive visual detection (complexes with high extinction coefficients). Other ligands for use with the present invention include Iron, Zinc and Magnesium for targeting using different ligands.

FIG. 4 depicts an example of color changes triggered by the chemistry of copper ions. By targeting adventitious copper present already on the skin, desired ligands would capture copper, creating a green complex. Next, the skin proteins reduce cupric ions to produce a color change to purple. The copper color change is known to work on proteins. The key development effort would focus upon making this compatible with the existing formulation. Finally, deactivator present in the hand sanitizer (succinic acid) would sequester the copper from the dye, rendering it colorless.

### EXAMPLE 5

### pH Controlled Color Appearance Concomitant with Dispensing of Product

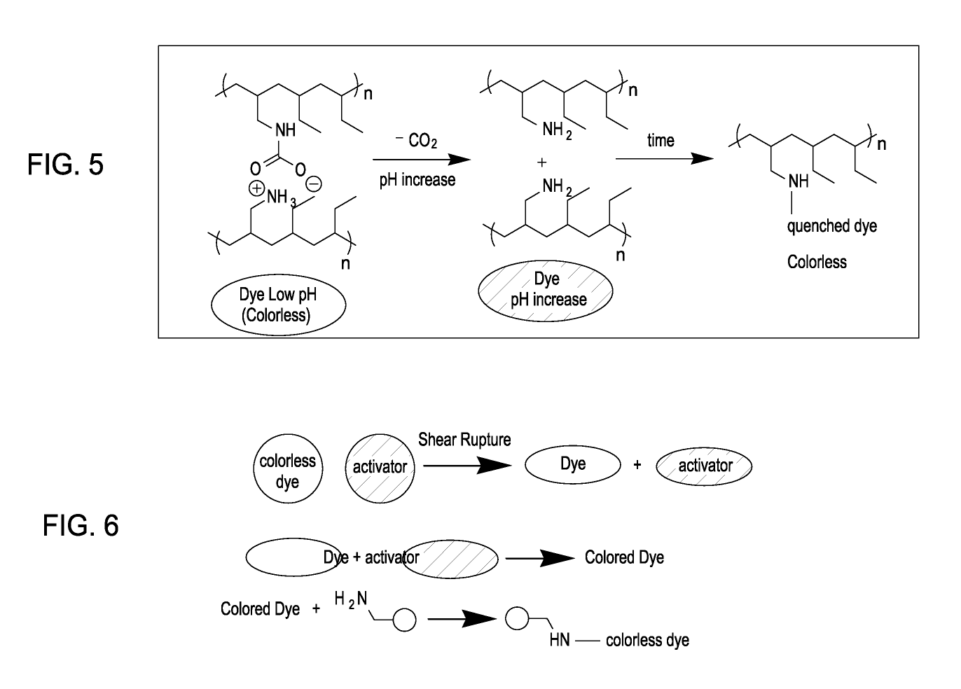

This example uses the following materials that have the subsequent attributes: Colorless dyes at low pH will be turned on with an increase in pH generating a brilliant and pleasant color. FIG. 5 shows an example of dye modulation achieved via pH control and quenching compound.

Spontaneous increase in pH would occur upon exposure to the atmosphere, however, this change will not be dependent upon oxygen. Carbon dioxide trapped via stabilized chemical species would escape to the atmosphere, raising the pH. The concentration of CO₂ and its subsequent escape would not be evident to the consumer (fizzing or bubbling).

Dye ‘control’ is accomplished through gellation or stabilization with dye additives. For example, ion-paired carbamate sol-gels formed from the reversible “crosslinking reaction” of low molecular weight polyallylamine with sequestered carbon dioxide provide the mechanism through which pH dependent dyes transition from colorless to colored. The gels are compatible with the existing product formulations and would stabilize and trap CO₂. The closed container and inherent viscosity of the product contribute to the stabilized sol-gel.

The liberated polymer with active amino groups would scavenge and deactivate the dye through a new covalent bond, making the entire formulation colorless.

### EXAMPLE 6

### Hand Shear Activation and Release of Microsphere Contents

A colorless dye would be part of the hand sanitizer mixture. Dye activator would be encapsulated in a microsphere that would rupture while rubbing the hands together. The 20 micrometer spheres would be undetectable to the consumer (unless otherwise desired).

FIG. 6 shows color changes using micro-encapsulation.

The deactivator, while also in a microsphere, would not rupture, but instead quench, or scavenge the dye, rendering it colorless. The encapsulated deactivator is too large to escape the matrix, but its functional groups are linked as chains that possess sufficient mobility to capture and reproducibly turn off the dye. Since the activator has yet to be released, the deactivator and the dye do not interact. By rubbing the hands together with sanitizer, the deactivator mixes with the dye, rendering it colorless.

The embodiment of the deactivator would comprise a microencapsulated nucleophile that chemically changes the dye to render it incapable of transmitting visible light. While trapped within the microsphere, and incapable of rupturing (under stresses expected during hand washing), the scavenging groups would then “mop-up” the activator. To the end user, a gradual disappearance of color would be observed, as the nucleophilic scavenger is ‘mixed’ through the process of hand rubbing.

### EXAMPLE 7

### Reversible Amidine Activity Controlled by the Complexation/Decomplexation with Carbon Dioxide

This example uses the following materials and have the subsequent attributes: Sequestration of carbon dioxide by amidine functional groups would be exploited to cause color change. Carbon dioxide would be generated in situ from a spontaneous decarboxylation of a β-keto ester, turning on the amidine dye rendering a colored product.

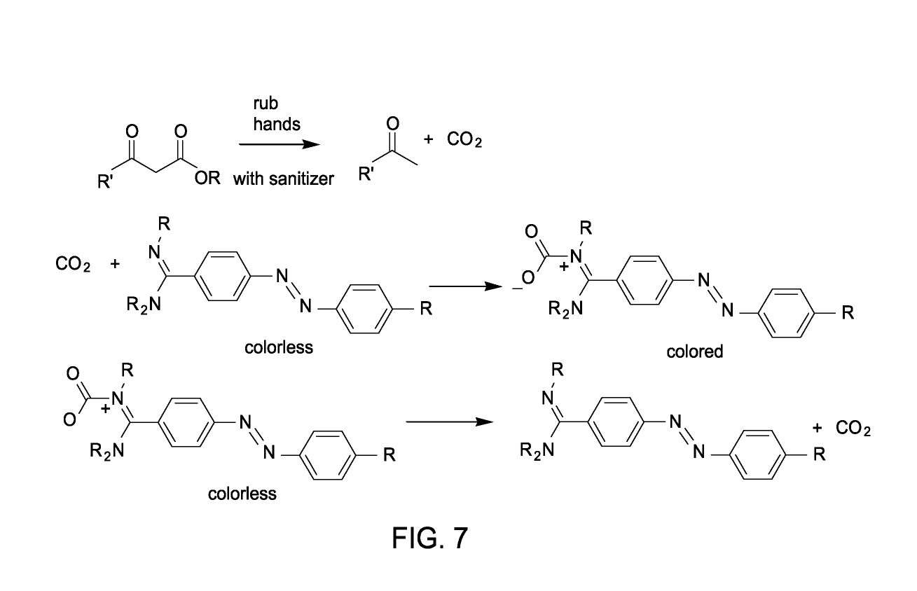

FIG. 7 shows color changes mediated through the sequestration of carbon dioxide.

Once exposed to open atmosphere from continual rubbing of the hands together would change the color of the amidine back to colorless through the release of CO₂. The dye could be electronically connected with the amidine/CO₂ group, upon loss of CO₂ the color would disappear.

To further the color properties of the mixture, secondary metal ion salts may be added to attenuate or quench the color, thus ensuring the maximum compatibility between the existing formulation and Surfactant Dye.

TABLE 1
Color-changing active ingredients.

| Color-changing | Examples in | | Typical Concentration |
|---|---|---|---|
| Ingredient | Patent | Concentration range | range |
| Pigment | 1, 2 | 0.0001% to 30% | 0.01% to 5% |
| Dyes | 1, 2 | 0.0001% to solubility limit | 0.01% to 5% |
| Nucleophile (oximate) | 1, 4, 5, 6, | 1 to 100 molar equivalents | 1 to 10 molar equivalents |
| | | of dye | of dye |
| Self-assembled | 2 | 1 to 100 molar equivalents | 1 to 10 molar equivalents |
| microcapsules | | of dye to achieve critical | of dye to achieve critical |
| (phospholipids) | | micelle concentration | micelle concentration |
| Amidine/CO₂ pH | 2 | 1 to 1000 molar | 10 to 100 molar |
| mechanism | | equivalents of dye | equivalents of dye |
| Copper(II) chelating dye | 4 | 0.0001% to solubility limit | 0.01% to 5% |
| Succinic Acid | 4 | 1 to 100 molar equivalents | 1 to 10 molar equivalents |
| | | dye | of dye |
| Polyallylamine/carbamate | 5 | 0.5% to 10% | 1% to 5% |
| sol-gels | | | |
| Micro-encapsulation | 1, 6 | 0.5% to solubility limit of | 2% alginic acid, 1% |
| (alginic acid/calcium | | alginic acid, 0.5% to 10% | calcium salt |
| cross-linked polymer) | | calcium salt | |
| Amidine | 7 | 1 equivalent to 1000 molar | 10 to 100 molar |
| | | equivalents of dye | equivalents of dye |
| β-keto ester | 7 | 1 to 1000 molar | 10 to 100 molar |
| | | equivalents of dye | equivalents of dye |
| Chelating agent | optional | 1 to 100 molar equivalents | 1 to 10 molar equivalents |
| | | of dye | of dye |

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A composition for detection of the effectiveness of a substance for cleaning comprising:
an electrophilic dye, wherein the electrophilic dye is colorless before exposure to a nucleophilic agent, and
a nucleophilic agent, wherein the electrophilic dye, the nucleophilic agent or both are encapsulated and wherein exposure to one or more cognate target or condition triggers the release of the electrophilic dye, the nucleophilic agent or both from encapsulation.

2. The composition of claim 1, wherein the composition is adapted for household products selected from laundry care; paper products; specialty cleaners (chlorinated cleaners, scouring pads, effervescent toilet bowl cleaner powders); air fresheners and combinations thereof.

3. The composition of claim 1, wherein the composition is adapted for personal care selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof.

4. The composition of claim 1, wherein the composition is adapted for the detection of desired levels of cleanliness, detection of microorganisms in cleaning products, detection of contamination of surfaces, detection of microorganisms in cleaning products and combinations thereof.

5. The composition of claim 1, wherein the composition is adapted for use in sanitizers that do not require a rinse.

6. The composition of claim 1, wherein the composition is biodegradable, biocompatible or both.

7. The composition of claim 1, wherein the condition is selected from pressure, friction, temperature change, gas, electromagnetic radiation, ultrasound, humidity and combinations thereof.

8. The composition of claim 1, wherein the nucleophile is an oxamate anion that quenches an excited state of an electrophilic dye.

9. A dye system composition comprising:
a container comprising:
an electrophilic dye, wherein the electrophilic dye is colorless before exposure to a nucleophilic agent, and
an nucleophilic agent, wherein the electrophilic dye, the nucleophilic agent or both are encapsulated, wherein exposure to one or more cognate target or condition triggers the release of the electrophilic dye, the nucleophilic agent or both from encapsulation.

10. The system of claim 9, wherein the composition is adapted for household products selected from laundry care; paper products; specialty cleaners (chlorinated cleaners, scouring pads, effervescent toilet bowl cleaner powders); air fresheners and combinations thereof.

11. The system of claim 9, wherein the composition is adapted for personal care selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof.

12. The system of claim 9, wherein the composition is adapted for the detection of desired levels of cleanliness, detection of microorganisms in cleaning products, detection of contamination of surfaces, detection of microorganisms in cleaning products and combinations thereof.

13. The system of claim 9, wherein the composition is adapted for use in sanitizers that do not require a rinse.

14. The system of claim 9, wherein the composition is biodegradable, biocompatible or both.

15. The system of claim 9, wherein the condition is selected from pressure, friction, temperature change, gas, electromagnetic radiation, ultrasound, humidity and combinations thereof.

16. The system of claim 9, wherein the nucleophile is an oxamate anion that quenches an excited state of an electrophilic dye.

17. A method for detection of the effectiveness of a composition for cleaning comprising:
providing an electrophilic dye, wherein the electrophilic dye is colorless before exposure to a nucleophilic agent and a nucleophilic agent, wherein the electrophilic dye, the nucleophilic agent or both are encapsulated, wherein exposure to one or more cognate target or condition triggers the release of the electrophilic dye, the nucleophilic agent or both from encapsulation; and
exposing the electrophilic dye and the nucleophilic agent to one or more conditions that trigger their release, wherein the dye reverts to a colorless state after a predetermined period of time by exposure to the nucleophilic agent.

18. The method of claim 17, wherein the composition is adapted for household products selected from laundry care; paper products; specialty cleaners (chlorinated cleaners, scouring pads, effervescent toilet bowl cleaner powders); air fresheners and combinations thereof.

19. The method of claim 17, wherein the composition is adapted for personal care selected from hair care (shampoos, hair mousses, styling agents); skin care (body lotions, vitamin, aloe vera); bath products (moisture-triggered release products); body powders; toilet soap (milled or poured, ionic strength-triggered release) and combinations thereof.

20. The method of claim 17, wherein the composition is adapted for the detection of desired levels of cleanliness, detection of microorganisms in cleaning products, detection of contamination of surfaces, detection of microorganisms in cleaning products and combinations thereof.

21. The method of claim 17, wherein the composition is adapted for use in sanitizers that do not require a rinse.

22. The method of claim 17, wherein the composition is biodegradable, biocompatible or both.

23. The method of claim 17, wherein the condition is selected from pressure, friction, temperature change, gas, electromagnetic radiation, ultrasound, humidity and combinations thereof.

24. The method of claim 17, wherein the nucleophile is an oxamate anion that quenches an excited state of an electrophilic dye.

25. A composition for detection of the effectiveness of a substance for cleaning comprising:
a recognitive dye, wherein the dye is colorless before exposure to its cognate target, changes color upon exposure to its cognate target and based on environmental conditions reverts to being colorless.

26. The composition of claim 25, wherein the composition is adapted for use in sanitizers that do not require a rinse.

27. The composition of claim 25, wherein the composition is colorless until exposed to ions that cause the dye to change color.

28. The composition of claim 25, wherein the composition is biodegradable, biocompatible or both.

29. The composition of claim 25, wherein the composition further comprises an encapsulated deactivator, wherein pressure, friction, heat or a combination thereof on the encapsulation triggers the release of the deactivator.

30. The composition of claim 25, wherein the composition further comprises an encapsulated deactivator, wherein the deactivator comprises a nucleophilic scavenger or a chelating agent.

31. The composition of claim 25, wherein the composition is adapted for use in sanitizers that do not require a rinse.

32. The composition of claim 25, wherein the dye does not stain skin, hair or clothing.

33. The composition of claim 25, wherein the dye is safe and mild for skin and eye contact.

34. The composition of claim 25, wherein the dye is a reversible amidine dye that reverts to colorless by exposure to CO₂.

35. A dye system composition comprising:
a chemical dye having an reactive site and a functional group, wherein the dye has a high affinity for a cognate bingeing agent and is colorless in the absence of the cognate bingeing agent; and
one or more encapsulated chelating agents, wherein mild friction breaks the encapsulation.

36. A method for detection of the effectiveness of a composition for cleaning comprising:
providing a recognitive dye, wherein the dye is colorless before exposure to its cognate target, changes color upon exposure to its cognate target and reverts to being colorless; and
exposing the recognitive dye to a surface suspected of having the dye's cognate target, wherein exposure to the cognate target changes the dye from colorless to colored, and wherein the dye reverts to a colorless state after a predetermined period of time by exposure to one or more environmental agents.

37. The method of claim 36, wherein the composition is adapted for use in sanitizers that do not require a rinse.

38. The method of claim 36, wherein the composition is colorless until exposed to ions that cause the dye to change color.

39. The method of claim 36, wherein the composition is biodegradable, biocompatible or both.

40. The method of claim 36, wherein the composition further comprises an encapsulated deactivator, wherein pressure, friction, heat or a combination thereof on the encapsulation triggers the release of the deactivator.

41. The method of claim 36, wherein the composition further comprises an encapsulated deactivator, wherein the deactivator comprises a nucleophilic scavenger or a chelating agent.

42. The method of claim 36, wherein the composition is adapted for use in sanitizers that do not require a rinse.

43. The method of claim 36, wherein the dye does not stain skin, hair or clothing.

44. The method of claim 36, wherein the dye is safe and mild for skin and eye contact.

45. The method of claim 36, wherein the dye is a reversible amidine dye that reverts to colorless by exposure to CO₂.

46. The method of claim 36, wherein the dye is adapted for the detection of coverage of sanitizer on the desired cleaning area.

47. The method of claim 36, wherein the dye is adapted for the disappearance of the detection system upon reaching a desired coverage.
